(19) United States
(12) Patent Application Publication
(10) Pub. No.: US 2018/0238572 A1
(43) Pub. Date: Aug. 23, 2018

(54) MODELING AND CONTROLLING HEATING, VENTILATION, AND AIR CONDITIONING SYSTEMS

(71) Applicants: SunPower Corporation, San Jose, CA (US); Total Marketing Services, Puteaux (FR)

(72) Inventors: Sugumar Murugesan, Foster City, CA (US); Brice Chung, Oakland, CA (US)

(21) Appl. No.: 15/438,619

(22) Filed: Feb. 21, 2017

(51) Int. Cl. F24F 11/00; G05B 13/04; G05D 23/19

(52) U.S. Cl. CPC F24F 11/006; F24F 11/0012; G05B 13/04; F24F 2005/0067; F24F 2011/0061; F24F 2011/0047; F24F 2011/0046; G05D 23/1917

(57) ABSTRACT

Methods, systems, and computer storage media are disclosed for modeling HVAC systems. In some examples, a method is performed by a computer system and includes receiving training data for thermal modeling of one or more buildings of a geographic area. The training data includes disaggregated HVAC load data for the buildings of the geographic area and outdoor temperature data for the geographic area. The method includes determining a thermal resistance value and a thermal capacity value characterizing the buildings of the geographic area. The thermal resistance value characterizes a rate of energy transfer by each of the buildings due to conductance and the thermal capacity value characterizes an amount of energy used to change an indoor temperature of each of the buildings per unit change in temperature. The method includes modeling HVAC operation for a particular building of the geographic area using a thermal resistance-capacity model.

### BACKGROUND

The subject matter described in this specification relates generally to heating, ventilation, and air conditioning (HVAC) systems and computer systems programmed for modeling and controlling HVAC systems.

HVAC systems provide thermal comfort and acceptable indoor air quality to buildings such as single family homes, apartment buildings, hotels, skyscrapers, and hospitals. HVAC systems typically include one or more heaters to generate heat, ventilation for changing or replacing air to control temperature and other air quality measures, and one or more air conditioners to provide cooling and humidity control. HVAC systems can draw a significant portion of the total power consumption of a building. Manufacturers of HVAC equipment have been improving the energy efficiency of HVAC systems, e.g., by using improved refrigerant and two-stage air conditioners. Some building systems use computers to model HVAC operation and schedule energy consumption adjustments to achieve energy consumption reduction goals.

### SUMMARY

A computer system is programmed for modeling HVAC systems. The computer system can be useful, e.g., for controlling HVAC systems and load-shifting HVAC controllers, and for determining accurate predictions of self-consumption of solar power. In some examples, the computer system includes memory storing one or more computer programs and one or more processors configured to execute the one or more computer programs to perform a method for modeling HVAC systems.

In some examples, the method includes receiving training data for thermal modeling of one or more buildings of a geographic area. The training data includes disaggregated HVAC load data for the buildings of the geographic area and outdoor temperature data for the geographic area. The method includes determining, using the training data, a thermal resistance value and a thermal capacity value characterizing the buildings of the geographic area. The thermal resistance value characterizes a rate of energy transfer by each of the buildings due to conductance and the thermal capacity value characterizes an amount of energy used to change an indoor temperature of each of the buildings per unit change in temperature. The method includes modeling HVAC operation for a particular building of the geographic area using a thermal resistance-capacity model and the thermal resistance value and the thermal capacity value for the buildings of the geographic area.

The computer systems described in this specification may be implemented in hardware, software, firmware, or combinations of hardware, software and/or firmware. The computer systems described in this specification may be implemented using a non-transitory computer storage medium storing one or more computer programs that, when executed by one or more processors, cause the one or more processors to perform the method for electric energy flow prediction for photovoltaic solar systems. Computer storage media suitable for implementing the computer systems described in this specification include non-transitory computer storage media, such as disk memory devices, chip memory devices, programmable logic devices, random access memory (RAM), read only memory (ROM), optical read/write memory, cache memory, magnetic read/write memory, flash memory, and application specific integrated circuits. A computer storage medium used to implement the computer systems described in this specification may be located on a single device or computing platform or may be distributed across multiple devices or computing platforms.

### BRIEF DESCRIPTION OF THE DRAWINGS

FIG. 1 is a diagram of an example electric system;

FIG. 2 is a block diagram of an example computer system programmed for modeling HVAC operation;

FIGS. 3A-B illustrate examples of HVAC load modeling for one or more buildings of a geographic location;

FIGS. 4A-B illustrate example deployment environments for HVAC modeling computer systems;

FIG. 5 is a flow diagram of an example method for determining, using training data, a thermal resistance value and a thermal capacity value characterizing one or more buildings of a geographic area;

FIG. 6 is a flow diagram of an example method for modeling HVAC operation; and

FIG. 7 is a flow diagram of an example method for controlling one or more HVAC systems of one or more buildings having photovoltaic solar systems.

### DETAILED DESCRIPTION

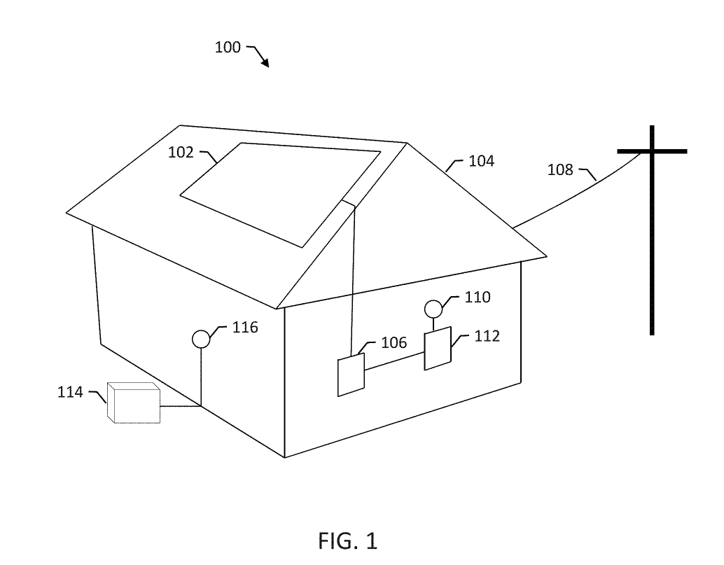

FIG. 1 is a diagram of an example electric system 100. The electric system 100 includes one or more photovoltaic solar panels 102 mounted on a building 104 and one or more inverters 106 coupled to the photovoltaic solar panels 102. The electric system 100 includes a connection 108 to a utility grid, an electric meter 110 for the connection 108 to the utility grid, and an electric panel 112 for the electric system 100.

The electric system 100 further includes an HVAC system 114 and a controller 116 for the HVAC system 114. The HVAC system 114 may include one or more heaters or one or more air conditioners or both. The controller 116 can be implemented as a thermostat and electronics configured to control the HVAC system 114 to regulate an indoor temperature of the building 104. For example, the controller 116 may be a Wi-Fi capable smart thermostat that includes one or more processors programmed with user-configurable indoor set-point temperatures and operation schedules.

When the sun is shining on the photovoltaic solar panels 102, the photovoltaic solar panels 102 produce direct current (DC) electric power and provide the DC power to the inverters 106. In response, the inverters 106 provide alternating current (AC) power for consumption by one or more loads on the electric system 100 or for exporting to the connection 108 to the utility grid. The loads can be located, e.g., inside or outside the building 104. The HVAC system 114 may consume a significant portion of the total power consumed by the loads.

When the loads on the electric system 100 are consuming more electric energy than the photovoltaic solar panels 102 are producing, the electric system 100 imports electric energy from the connection 108 to the utility grid. When the loads are consuming less electric energy than the photovoltaic solar panels 102 are producing, the electric system 100 can export the excess electric energy to the connection 108 to the utility grid. Some electric utilities do not allow or compensate for energy export, so that when the loads are consuming less electric energy than the photovoltaic solar panels 102 are producing, the excess electric energy may be unused.

For an electric system manager considering installing a prospective photovoltaic solar system, determining accurate predictions of HVAC operation and consumption can be useful for various purposes. For example, accurate predictions of HVAC consumption can be useful in determining whether or not to install the prospective photovoltaic solar system, determining an appropriate physical configuration for the prospective photovoltaic solar system, and predicting cost reductions or other financial information. Determining accurate predictions of HVAC consumption, however, may be challenging if data available for HVAC modeling is not available.

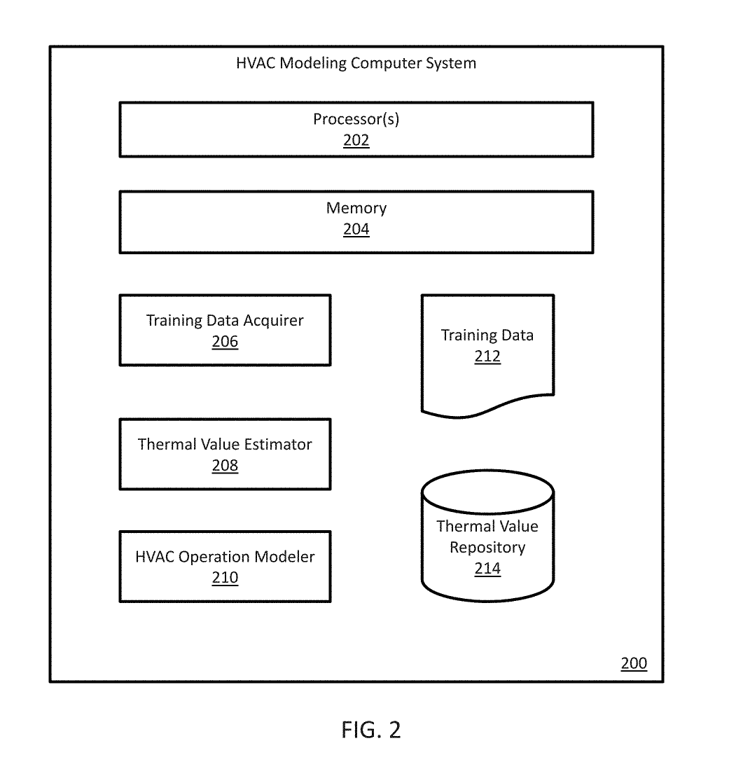

FIG. 2 is a block diagram of an example computer system 200 programmed for modeling HVAC operation. The computer system 200 includes one or more processors 202 and memory 204 storing one or more computer programs for execution by the processors 202. The computer system 200 includes a training data acquirer 206, a thermal value estimator 208, and an HVAC operation modeler 210, each of which can be implemented as one or more computer programs.

In operation, the training data acquirer 206 receives training data 212 for thermal modeling of one or more buildings of a geographic area. The training data 212 includes disaggregated HVAC load data for the buildings of the geographic area and outdoor temperature data for the geographic area. For example, the disaggregated HVAC load data can include, for each building, a time series of disaggregated HVAC load values over a time period such as a year. The outdoor temperature data can include a time series of temperatures (e.g., dry bulb temperatures) measured in the geographic area over the time period. In some examples, the training data acquirer 206 requests the training data 212 from a web server hosting various data sets related to energy consumption.

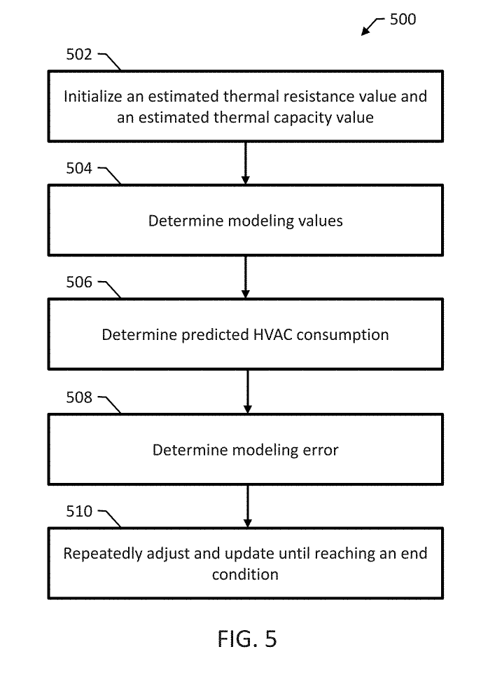

The thermal value estimator 208 determines, using the training data 212, a thermal resistance value (R) and a thermal capacity value (C) characterizing the buildings of the geographic area. The thermal resistance value R characterizes a rate of energy transfer by each of the buildings due to conductance. For example, the inverse of R, 1/R, can specify a thermal conductance of the energy lost by a building per unit time, per unit temperature differential at the boundary with the ambient air (e.g., in kW/K). The thermal capacity value C characterizes an amount of energy used to change an indoor temperature of each of the buildings per unit change in temperature (e.g., in kWh/K). Determining thermal resistance values and thermal capacity values is discussed further below with reference to FIG. 5.

In some examples, the thermal value estimator 208 is configured to determine thermal resistance and capacity values for each geographic area number of different geographic areas. The thermal value estimator 208 can then store the thermal resistance and capacitance values in a thermal value repository 214. The thermal value repository 214 can be indexed, e.g., by geographic area. The thermal value estimator 208 can also be configured to determine thermal resistance and capacity values for specific buildings and store those values in the thermal value repository 214, e.g., indexed by street address or any other appropriate building identifier.

The HVAC operation modeler 210 models HVAC operation using the thermal resistance and capacity values and a thermal resistance-capacity model. The HVAC operation modeler 210 can model HVAC operation for a particular building using the thermal resistance and capacitance values for the geographic area matching the particular building and the thermal resistance-model. For example, the HVAC operation modeler 210 can determine a geographic location of the particular building, e.g., using a street address or zip code, and then match the particular building to the geographic area by searching the thermal value repository 214 and determining that the geographic area encompasses or is the nearest geographic area to the geographic location of the particular building.

The thermal resistance-capacity model can be based on the concept that HVAC energy injected over a given time interval is equal to the energy lost via conductance in that interval plus the energy used to increase indoor temperature in that interval. To illustrate an example thermal resistance-capacity model, consider the following parameter definitions:
R :=Thermal resistance of the home
C :=Thermal capacity of the home
Tᵢₙ₋ₘᵢₙᵤₛ(t) :=Lowest indoor set-point temperature allowed, at time t
Tᵢₙ₋ₚₗᵤₛ(t) :=Highest indoor set-point temperature allowed, at time t
Tᵢₙ(t) :=Indoor temperature, at time t
Tₒᵤₜ(t) :=Outdoor temperature, at time t
P_{hvac} :=Peak power of operation of HVAC
T_{min-hvac} :=Minimum cycle (ON) time for HVAC
S_{hvac}(t) :=ON/OFF state of HVAC at time t
E_{hvac}(t) :=Energy consumption of HVAC over time (t−Δt, t]

With these parameter definitions, the thermal resistance-capacity model for winter (anytime when it is colder outside than a configured indoor temperature) can be expressed as:

$${E}_{hvac} ( t ) = \frac{1}{R} ( {T}_{in} ( t ) - {T}_{out} ( t ) ) Δ t + C ( {T}_{in} ( t ) - {T}_{in} ( t - Δ t ) ) \qquad ( 1 )$$

Similarly, the thermal resistance-capacity model for summer (anytime when it is warmer outside than a configured indoor temperature) can be expressed as:

$${E}_{hvac} ( t ) = \frac{1}{R} ( {T}_{out} ( t ) - {T}_{in} ( t ) ) Δ t + C ( {T}_{in} ( t - Δ t ) - {T}_{in} ( t ) ) \qquad ( 2 )$$

Using this thermal resistance-capacity model, the HVAC operation modeler 210 can model HVAC operation in two phases. In a first phase, the HVAC operation modeler 210 determines the ON/OFF state of an HVAC system. The HVAC operation modeler 210 determines a time series of ON/OFF state determines over a time period such as a 24 hour day. The HVAC operation modeler 210 uses the thermal resistance and capacity values and modeling values for the lowest indoor set-point temperature allowed and highest indoor set-point temperature value to determine whether the HVAC system is ON or OFF.

The ON/OFF state during winter operation can be determined as follows:
At time (t−Δt, t],
If (Tᵢₙ(t−Δt)>Tᵢₙ₋ₚₗᵤₛ(t−Δt))
   Cut-out HVAC, Set S_{hvac}(t)=OFF
Else if (Tᵢₙ(t−Δt)>Tᵢₙ₋ₘᵢₙᵤₛ(t−Δt))
   If S_{hvac}(t−Δt)=ON
      Set S_{hvac}(t)=ON, HVAC is on ramp-up from cut-in to cut-out
   Else
      Set S_{hvac}(t)=OFF, HVAC is on ramp-down from cut-out to cut-in
Else
   Cut-in HVAC, Set S_{hvac}(t)=ON

The ON/OFF state during summer operation can be determined as follows:
At time (t−Δt, t],
If (Tᵢₙ(t−Δt)<Tᵢₙ₋ₘᵢₙᵤₛ(t−Δt))
   Cut-out HVAC, Set S_{hvac}(t)=OFF
Else if (Tᵢₙ(t−Δt)<Tᵢₙ₋ₚₗᵤₛ(t−Δt))
   If S_{hvac}(t−Δt)=ON
      Set S_{hvac}(t)=ON, HVAC is on ramp-up from cut-in to cut-out
   Else
      Set S_{hvac}(t)=OFF, HVAC is on ramp-down from cut-out to cut-in
Else
   Cut-in HVAC, Set S_{hvac}(t)=ON

With the ON/OFF state of the HVAC system determined in the first phase, the HVAC operation modeler 210 determines the indoor temperature modulation in a second phase. The HVAC operation modeler 210 can determine a time series of indoor temperature values during winter operation as follows:
If S_{hvac}(t)=ON
   E_{hvac}(t)=P_{hvac}Δt
   Solve for Tᵢₙ(t) from:

$${E}_{hvac} ( t ) = \frac{1}{R} ( {T}_{in} ( t ) - {T}_{out} ( t ) ) Δ t + C ( {T}_{in} ( t ) - {T}_{in} ( t - Δ t ) )$$

Repeat from Step 1 for time (t, t+Δt]
Else
   E_{hvac}(t)=0
   Solve for Tᵢₙ(t) from:

$${E}_{hvac} ( t ) = \frac{1}{R} ( {T}_{in} ( t ) - {T}_{out} ( t ) ) Δ t + C ( {T}_{in} ( t ) - {T}_{in} ( t - Δ t ) )$$

Repeat from Step 1 for time (t, t+Δt]

Similarly, the HVAC operation modeler 210 can determine a time series of indoor temperature values during summer operation as follows:
If S_{hvac}(t)=ON
   E_{hvac}(t)=P_{hvac}Δt
   Solve for Tᵢₙ(t) from:

$${E}_{hvac} ( t + {t}_{shift} ) = \frac{1}{R} ( {T}_{out} ( t ) - {T}_{in} ( t ) ) Δ t + C ( {T}_{in} ( t - Δ t ) - {T}_{in} ( t ) )$$

Repeat from Step 1 for time (t, t+Δt]
Else
   E_{hvac}(t)=0
   Solve for Tᵢₙ(t) from:

$${E}_{hvac} ( t + {t}_{shift} ) = \frac{1}{R} ( {T}_{out} ( t ) - {T}_{in} ( t ) ) Δ t + C ( {T}_{in} ( t - Δ t ) - {T}_{in} ( t ) )$$

Repeat from Step 1 for time (t, t+Δt]

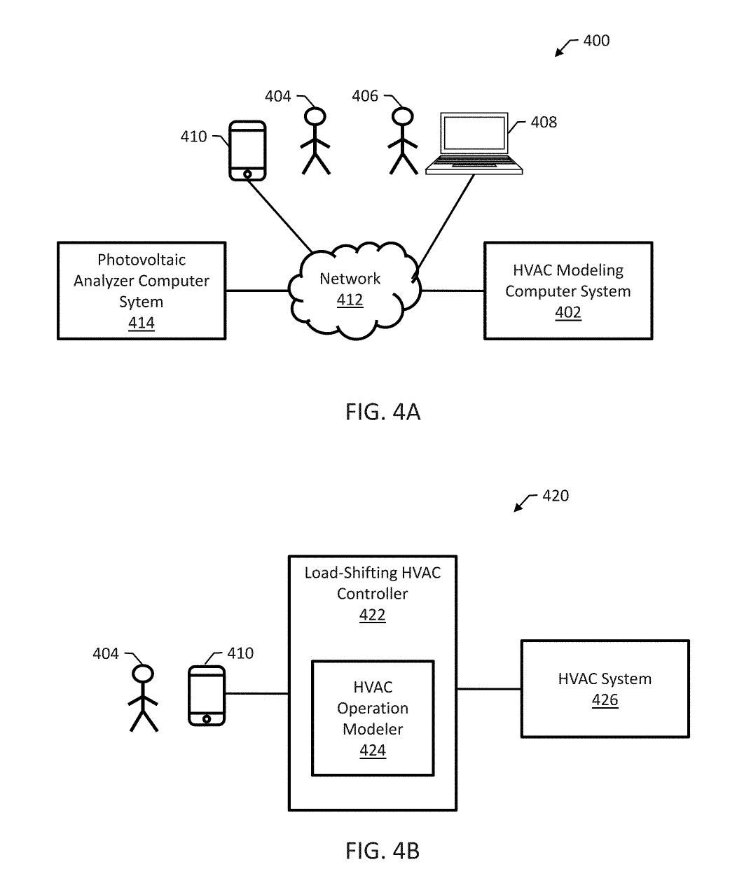

After the second phase, the HVAC operation modeler 210 can output the time series for the HVAC ON/OFF state or the time series for the indoor temperature or both. For example, the HVAC operation modeler 210 can output data to a photovoltaic analyzer computer system as described below with reference to FIG. 4A or to a load-shifting HVAC controller as described below with reference to FIG. 4B. Similarly, the HVAC operation modeler 210 may output any other appropriate data generated during modeling, e.g., the time series for the energy consumed by the HVAC system.

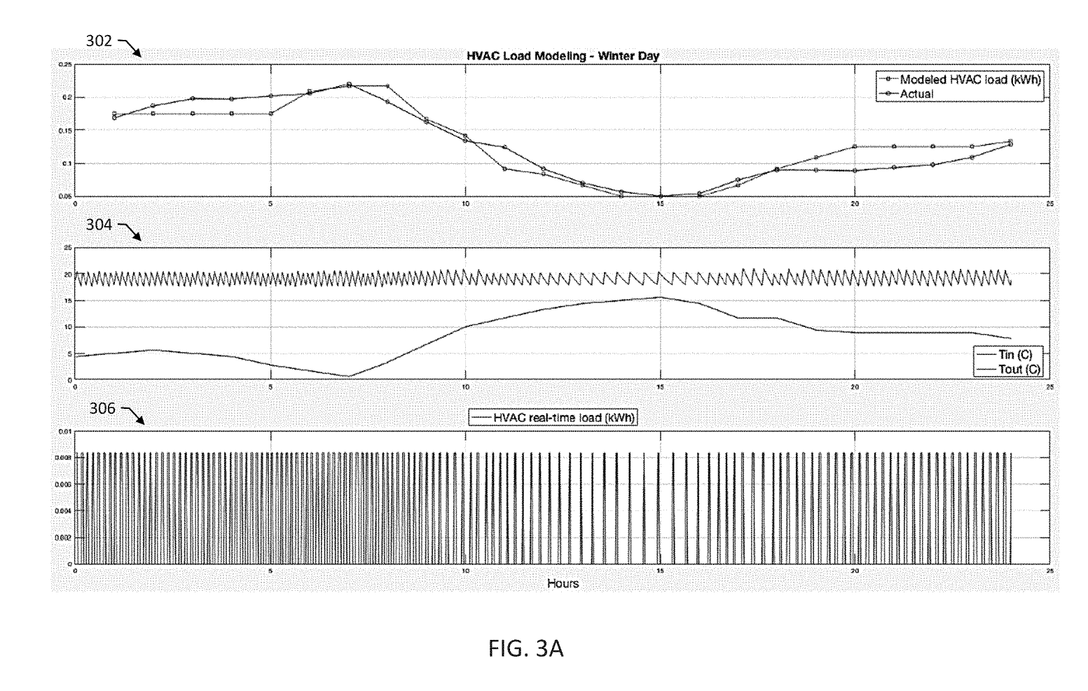

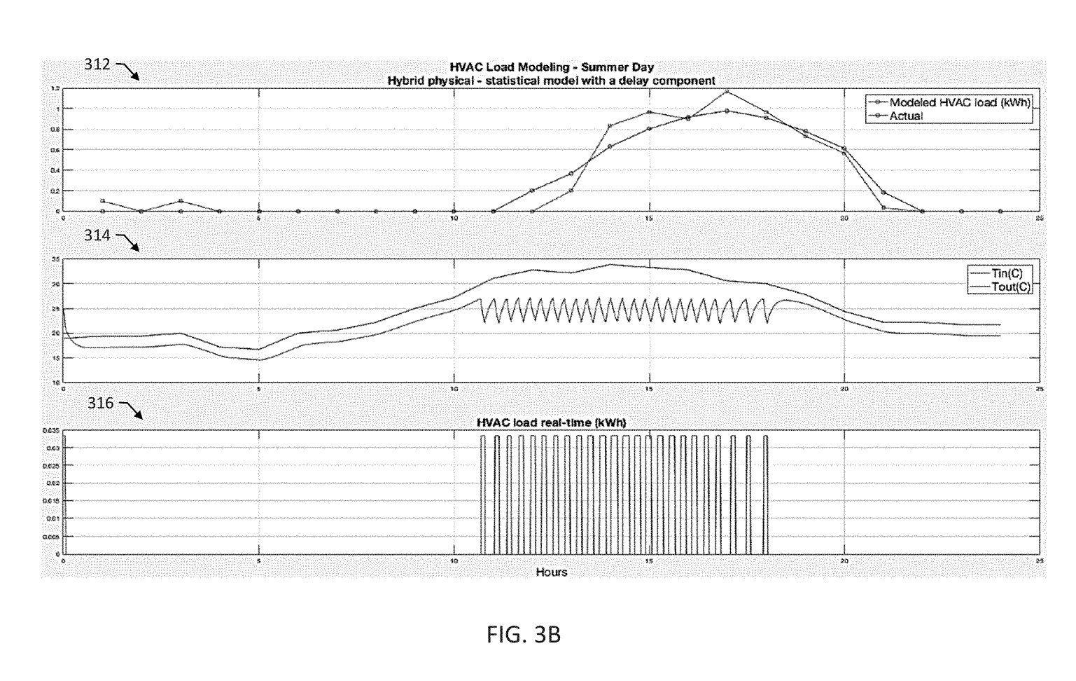

FIGS. 3A-B illustrate examples of HVAC load modeling for one or more buildings of a geographic location. FIG. 3A shows three plots 302, 304, and 306 illustrating HVAC load modeling for a time period of a winter day for the geographic location, i.e., so that one or more heaters are warming one or more buildings. The first plot 302 shows a modeled HVAC load versus an actual, measured HVAC load. The second plot 304 shows the indoor temperature modulation of the one or more buildings versus the outdoor temperature modulation over the course of the day. The third plot 306 shows the HVAC duty cycle by showing the HVAC real-time load in kWh.

FIG. 3B shows three plots 312, 314, and 316 illustrating HVAC load modeling for a time period of a summer day for the geographic location, i.e., so that one or more air conditioners are cooling one or more buildings. The first plot 312 shows a modeled HVAC load versus an actual, measured HVAC load. The second plot 314 shows the indoor temperature modulation of the one or more buildings versus the outdoor temperature modulation over the course of the day. The third plot 316 shows the HVAC duty cycle by showing the HVAC real-time load in kWh.

FIGS. 4A-B illustrate example deployment environments for HVAC modeling computer systems. HVAC modeling computer systems can be deployed in various other appropriate applications, and FIGS. 4A-B illustrate two examples for purposes of illustration.

FIG. 4A is a block diagram illustrating an example network environment 400 of an HVAC modeling computer system 402 programmed for modeling HVAC operation using a thermal resistance-capacity model, e.g., the example computer system 200 of FIG. 2. A manager 404 of an electric system is considering a prospective photovoltaic solar system.

For example, the manager 404 may be in a procurement process for the photovoltaic solar system, or the manager 404 may have recently installed the photovoltaic solar system and lacks certain kinds of predictions regarding the installed system. The manager 404 can be a residential homeowner or a commercial building manager or any appropriate individual associated with the electric system. The manager 404 consults with an installer 406 of photovoltaic solar systems.

The installer 406 operates a user device 408 to communicate with a photovoltaic analyzer computer system 414 and the HVAC modeling computer system 402 over a data communications network 412. The manager 404 may also operate a user device 410. The user devices 408 and 410 can each be any appropriate computer system, e.g., a computer system with a display and a user input device such as a personal computer, laptop, or tablet computer.

The photovoltaic analyzer computer system 412 can be implemented as a cloud-based service, e.g., as a server implemented on a distributed computing platform. The HVAC modeling computer system 402 and the photovoltaic analyzer computer system 414 are illustrated as separate systems; however, the computer programs executed on each of the systems can be implemented on a single computer system such as a distributed computing system executing a web server or any appropriate computing system.

The photovoltaic analyzer computer system 412 is programmed to import electric energy flow data from one or more of various sources including the installer's user device 308, the manager's user device 310, and the HVAC modeling computer system 402. The photovoltaic analyzer computer system 414 is programmed for determining energy flow predictions and presenting results for display on the installer's user device 408 or the manager's user device 410 or both. The results can include, for example, a target physical configuration of the prospective photovoltaic solar system or a predicted energy cost reduction or both.

In some examples, the installer 406 executes a web browser on the user device 408 and enters a uniform resource locator (URL) into the web browser for a web server executing on the photovoltaic analyzer computer system 414. The photovoltaic analyzer computer system 414 provides a graphical user interface (GUI) to the user device 408, e.g., as one or more web pages which can be comprised of hypertext markup language (HTML) files and image files. The installer 406 can then supply data to the photovoltaic analyzer computer system 414 using the GUI, and the photovoltaic analyzer computer system 414 can provide results on one or more display screens of the GUI. Based on the results, the manager 404 may have the installer 406 install the target physical configuration of the prospective photovoltaic solar system with the electric system.

The photovoltaic analyzer computer system 414 can be programmed for determining, e.g., a predicted import time series of electric import values each specifying an amount of electric energy predicted to be imported by the electric system with the prospective photovoltaic solar system installed. The photovoltaic analyzer computer system 414 can use any appropriate techniques for predicting the electric import values. The photovoltaic analyzer computer system 414 may use data such as predicted production data from a photovoltaic simulator and predicted consumption data from a consumption simulator.

The photovoltaic system analyzer 414 uses the predicted import time series to determine results for the electric system and the prospective photovoltaic solar system. For example, the photovoltaic system analyzer 414 can predict a cost reduction for the prospective photovoltaic solar system using a utility rate structure, e.g., a utility rate structure that imposes charges based on each unit of energy imported in a metered interval in addition to net-metering balancing. Predicting a cost reduction can include determining a predicted cost of consumption without the prospective photovoltaic solar system installed, determining a predicted cost of consumption with the prospective photovoltaic solar system installed using the predicted import time series and the utility rate structure, and determining a difference between the two predicted costs.

In some examples, the photovoltaic system analyzer 414 determines a target physical configuration of the prospective photovoltaic solar system. The photovoltaic system analyzer 414 can determine predicted cost reductions with several different sizes and orientations of photovoltaic solar systems, e.g., different numbers and/or sizes of panels and solar cells. For example, the installer 406 may supply data characterizing available sizes of panels and solar cells, and the manager 404 may supply data characterizing available area and orientations for the panels. Then, the photovoltaic system analyzer 412 determines, as the target physical configuration, the configuration resulting in the greatest cost reduction.

FIG. 4B is a is a block diagram illustrating an example load-shifting HVAC controller 422 that is programmed to use an HVAC operation modeler 424 for controlling an HVAC system 426 of a building. The HVAC controller 422 can be implemented as a digital thermostat having one or more processors and memory for executing a control routine to control the HVAC system 426 based on a measured indoor temperature and optionally indoor maximum and minimum temperature set-points and other configurable preferences such as a schedule, e.g., a daily or weekly schedule of configured indoor temperatures. In some examples, the manager 404 can configure the load-shifting HVAC controller 422 using the user device 410, e.g., which is in communication with the load-shifting HVAC controller 422.

The HVAC operation modeler 424 can be, e.g., the HVAC operation modeler 210 of FIG. 2. As a resulting of modeling HVAC operation for the building, the load-shifting HVAC controller 422 determines an HVAC load-shifting operation for the HVAC system 426. For example, the load-shifting HVAC controller 422 may determine to shift an HVAC on-cycle to a time when a photovoltaic solar system of the building is producing power. In that case, the building may act as a thermal battery for the photovoltaic solar system, which may be particularly useful in situations where the utility company does not compensate for exported electric energy.

The load-shifting HVAC controller 422 can determine the HVAC load-shifting operation using any appropriate technique. For example, the load-shifting HVAC controller 422 may predict, as a result of modeling HVAC operation for the building, that shifting the HVAC on-cycle to the time when the photovoltaic solar system of the building is producing power will not cause an indoor temperature of the particular building to fall outside of an interior comfort range. The HVAC operation modeler 424 can model HVAC operation as described above with reference to FIG. 2, modify the HVAC on/off state time series in accordance with the load-shifting operation, and then determine a time series of indoor temperature values.

The load-shifting HVAC controller 422 can then compare the indoor temperature values with the interior comfort range and determine that none of the values (or a maximum number of values) fall outside the interior comfort range. The load-shifting HVAC controller 422 can use HVAC operation modeler 424 to model various load-shifting operations and decide to perform the load-shifting operations that are not predicted to cause the indoor temperature to fall outside the interior comfort range.

In some examples, HVAC operation modeler 424 is implemented on computer system remote from the load-shifting HVAC controller 422. In those examples, the HVAC operation modeler 424 can send a command to the load-shifting HVAC controller 422 to carry out the HVAC load-shifting operation. For example, the load-shifting HVAC controller 422 may be Wi-Fi enabled so that the HVAC operation modeler 424 can send the command over a Wi-Fi network in the building.

FIG. 5 is a flow diagram of an example method 500 for determining, using training data, a thermal resistance value and a thermal capacity value characterizing one or more buildings of a geographic area. The thermal resistance value characterizes a rate of energy transfer by each of the buildings due to conductance. The thermal capacity value characterizes an amount of energy used to change an indoor temperature of each of the buildings per unit change in temperature.

The method 500 includes initializing an estimated thermal resistance value and an estimated thermal capacity value (502). The method 500 includes determining modeling values for certain parameters (504), including:
Indoor set-point temperatures-Tᵢₙ₋ₘᵢₙᵤₛ(t) and Tᵢₙ₋ₚₗᵤₛ(t)
Peak power of operation of HVAC-P_{hvac}
Minimum cycle (ON) time for HVAC-T_{min-hvac}

The method 500 includes determining a predicted value of HVAC energy consumption using the estimated thermal resistance value, the estimated thermal capacity value, the modeling values, the outdoor temperature data, and a thermal resistance-capacity model (506). For example, a time series of predicted values of HVAC energy consumption can be determined, e.g., over a 24 hour period. Determining a predicted value of HVAC energy consumption can include determining an ON/OFF state of the HVAC system, e.g., as described above with reference to FIG. 2, and multiplying the amount of time that the HVAC system is in the ON state by a peak power consumption value or steady state power consumption value for the HVAC system.

The method 500 includes determining a modeling error for the predicted value of HVAC energy consumption using the disaggregated HVAC load data (508). Determining the modeling error includes comparing the predicted value with a corresponding value from the training data (e.g., a value for the same time of day). Any appropriate technique for determining an error can be used, e.g., the modeling error can be determined for a whole time series of predicted values of HVAC energy consumption.

The method 500 includes repeatedly adjusting the estimated thermal resistance value and estimated thermal capacity value, updating the predicted value of HVAC energy consumption, and updating the modeling error until reaching an end condition (510). For example, the method can include repeatedly adjusting and updating until the estimated thermal resistance value and estimated thermal capacity value minimizes the modeling error, or until a maximum number of iterations has been reached.

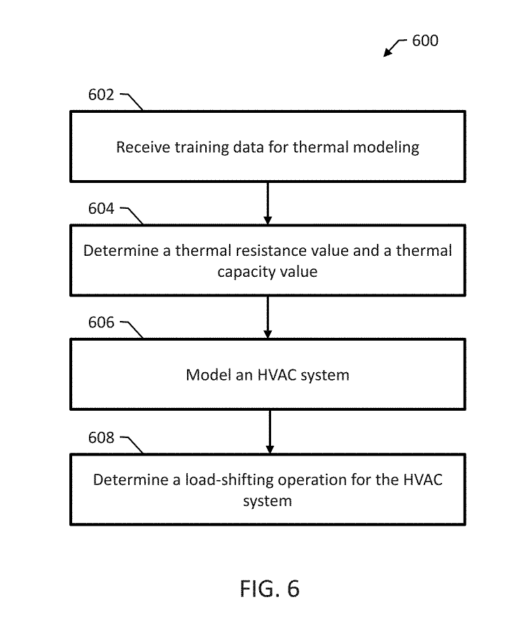

FIG. 6 is a flow diagram of an example method 600 for modeling HVAC operation. The method 600 is performed by a computer system, e.g., the HVAC modeling computer system 200 of FIG. 2.

The method 600 includes receiving training data for thermal modeling of one or more buildings of a geographic area, the training data including disaggregated heating, ventilation, and air conditioning (HVAC) load data for the buildings of the geographic area and outdoor temperature data for the geographic area (602). The method 600 includes determining, using the training data, a thermal resistance value and a thermal capacity value characterizing the buildings of the geographic area (604). The thermal resistance value characterizes a rate of energy transfer by each of the buildings due to conductance and the thermal capacity value characterizes an amount of energy used to change an indoor temperature of each of the buildings per unit change in temperature.

The method 600 includes modeling HVAC operation for a particular building of the geographic area using a thermal resistance-capacity model and the thermal resistance value and the thermal capacity value for the buildings of the geographic area (606). In some examples, the method includes determining, as a result of modeling HVAC operation for the particular building, an HVAC load-shifting operation for the particular building and sending a command to an HVAC controller of the particular building to carry out the HVAC load-shifting operation (608). For example, determining the HVAC load-shifting operation can include determining to shift an HVAC on-cycle to a time when a photovoltaic solar system of the particular building is producing power and predicting that shifting the HVAC on-cycle will not cause an indoor temperature of the particular building to fall outside of an interior comfort range.

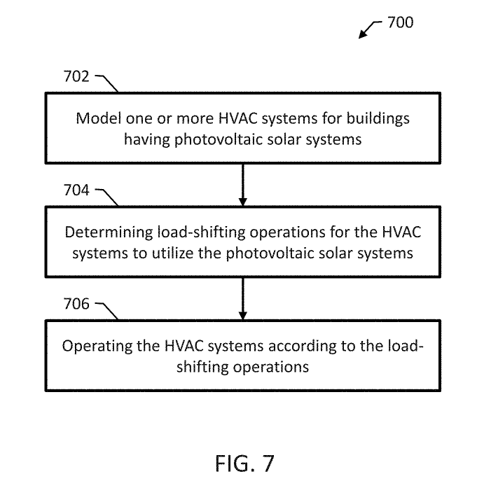

FIG. 7 is a flow diagram of an example method 700 for controlling one or more HVAC systems of one or more buildings having photovoltaic solar systems. The method 700 includes modeling the HVAC systems for the buildings, e.g., as described above with reference to FIGS. 2 and 5 (702). The method 700 includes determining load-shifting operations for the HVAC systems to utilize the photovoltaic solar systems (704). The method 700 includes operating the HVAC systems according to the load-shifting operations (706).

For example, determining the load-shifting operations can include determining to run heating or air conditioning during the daytime when the photovoltaic solar systems are supplying available power. Determining the load-shifting operations can include determining, based on modeling the HVAC systems, that time-shifting the heating or air conditioning will not cause the indoor temperature to go outside of a specified indoor temperature range. In some examples, determining the load-shifting operations includes: modeling the HVAC systems to predict on/off states of the HVAC systems without any load shifting; modeling a number of candidate load-shifting operations that place the HVAC systems into “on” states when the photovoltaic solar systems are supplying power or supplying more power (e.g., time-shifting an “on” state from 5:00 PM to 4:45 PM, and then from 5:00 PM to 4:30 PM); and then selecting a candidate load-shifting operation that is not predicted to violate the specified indoor temperature range.

Although specific examples and features have been described above, these examples and features are not intended to limit the scope of the present disclosure, even where only a single example is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed in this specification (either explicitly or implicitly), or any generalization of features disclosed, whether or not such features or generalizations mitigate any or all of the problems described in this specification. Accordingly, new claims may be formulated during prosecution of this application (or an application claiming priority to this application) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method performed by a computer system comprising one or more processors, the method comprising:
receiving, by the computer system, training data for thermal modeling of one or more buildings of a geographic area, the training data including disaggregated heating, ventilation, and air conditioning (HVAC) load data for the buildings of the geographic area and outdoor temperature data for the geographic area;
determining, by the computer system and using the training data, a thermal resistance value and a thermal capacity value characterizing the buildings of the geographic area, wherein the thermal resistance value characterizes a rate of energy transfer by each of the buildings due to conductance and the thermal capacity value characterizes an amount of energy used to change an indoor temperature of each of the buildings per unit change in temperature; and
modeling, by the computer system, HVAC operation for a particular building of the geographic area using a thermal resistance-capacity model and the thermal resistance value and the thermal capacity value for the buildings of the geographic area.

2. The method of claim 1, wherein determining the thermal resistance value and the thermal capacity value comprises:
initializing an estimated thermal resistance value and an estimated thermal capacity value;
determining modeling values for: indoor set-point temperatures including a high temperature and a low temperature, peak power HVAC operation, and minimum HVAC cycle time;
determining a predicted value of HVAC energy consumption using the estimated thermal resistance value, the estimated thermal capacity value, the modeling values, the outdoor temperature data, and the thermal resistance-capacity model;
determining a modeling error for the predicted value of HVAC energy consumption using the disaggregated HVAC load data; and
repeatedly adjusting the estimated thermal resistance value and estimated thermal capacity value, updating the predicted value of HVAC energy consumption, and updating the modeling error until the estimated thermal resistance value and estimated thermal capacity value minimizes the modeling error.

3. The method of claim 1, wherein modeling HVAC operation comprises determining an HVAC on/off state time series using indoor set-point temperatures including a high temperature and a low temperature.

4. The method of claim 3, wherein modeling HVAC operation comprises determining an HVAC energy consumption time series using the HVAC on/off state time series and a peak power HVAC operation value.

5. The method of claim 4, wherein modeling HVAC operation comprises determining an indoor temperature time series using the HVAC energy consumption time series, the outdoor temperature data, the thermal resistance-capacity model, and the thermal resistance value and the thermal capacity value.

6. The method of claim 1, comprising:
determining, for each other geographic area of a plurality of other geographic areas, a respective thermal resistance value and a respective thermal capacitance value for the other geographic area; and
modeling HVAC operation for a plurality of other buildings of the other geographic areas.

7. The method of claim 1, comprising determining, as a result of modeling HVAC operation for the particular building, an HVAC load-shifting operation for the particular building and sending a command to an HVAC controller of the particular building to carry out the HVAC load-shifting operation.

8. The method of claim 7, wherein determining the HVAC load-shifting operation comprises determining to shift an HVAC on-cycle to a time when a photovoltaic solar system of the particular building is producing power and predicting that shifting the HVAC on-cycle will not cause an indoor temperature of the particular building to fall outside of an interior comfort range.

9. A computer system comprising:
memory storing one or more computer programs; and
one or more processors configured to execute the one or more computer programs to perform operations comprising:
receiving training data for thermal modeling of one or more buildings of a geographic area, the training data including disaggregated heating, ventilation, and air conditioning (HVAC) load data for the buildings of the geographic area and outdoor temperature data for the geographic area;
determining, using the training data, a thermal resistance value and a thermal capacity value characterizing the buildings of the geographic area, wherein the thermal resistance value characterizes a rate of energy transfer by each of the buildings due to conductance and the thermal capacity value characterizes an amount of energy used to change an indoor temperature of each of the buildings per unit change in temperature; and
modeling HVAC operation for a particular building of the geographic area using a thermal resistance-capacity model and the thermal resistance value and the thermal capacity value for the buildings of the geographic area.

10. The computer system of claim 9, wherein determining the thermal resistance value and the thermal capacity value comprises:
initializing an estimated thermal resistance value and an estimated thermal capacity value;
determining modeling values for: indoor set-point temperatures including a high temperature and a low temperature, peak power HVAC operation, and minimum HVAC cycle time;
determining a predicted value of HVAC energy consumption using the estimated thermal resistance value, the estimated thermal capacity value, the modeling values, the outdoor temperature data, and the thermal resistance-capacity model;
determining a modeling error for the predicted value of HVAC energy consumption using the disaggregated HVAC load data; and
repeatedly adjusting the estimated thermal resistance value and estimated thermal capacity value, updating the predicted value of HVAC energy consumption, and updating the modeling error until the estimated thermal resistance value and estimated thermal capacity value minimizes the modeling error.

11. The computer system of claim 9, wherein modeling HVAC operation comprises determining an HVAC on/off state time series using indoor set-point temperatures including a high temperature and a low temperature.

12. The computer system of claim 11, wherein modeling HVAC operation comprises determining an HVAC energy consumption time series using the HVAC on/off state time series and a peak power HVAC operation value.

13. The computer system of claim 12, wherein modeling HVAC operation comprises determining an indoor temperature time series using the HVAC energy consumption time series, the outdoor temperature data, the thermal resistance-capacity model, and the thermal resistance value and the thermal capacity value.

14. The computer system of claim 9, the operations comprising:
determining, for each other geographic area of a plurality of other geographic areas, a respective thermal resistance value and a respective thermal capacitance value for the other geographic area; and
modeling HVAC operation for a plurality of other buildings of the other geographic areas.

15. The computer system of claim 9, the operations comprising determining, as a result of modeling HVAC operation for the particular building, an HVAC load-shifting operation for the particular building and sending a command to an HVAC controller of the particular building to carry out the HVAC load-shifting operation.

16. The computer system of claim 15, wherein determining the HVAC load-shifting operation comprises determining to shift an HVAC on-cycle to a time when a photovoltaic solar system of the particular building is producing power and predicting that shifting the HVAC on-cycle will not cause an indoor temperature of the particular building to fall outside of an interior comfort range.

17. A non-transitory computer storage medium storing one or more computer programs that, when executed by one or more processors, cause the one or more processors to perform operations comprising:
receiving training data for thermal modeling of one or more buildings of a geographic area, the training data including disaggregated heating, ventilation, and air conditioning (HVAC) load data for the buildings of the geographic area and outdoor temperature data for the geographic area;
determining, using the training data, a thermal resistance value and a thermal capacity value characterizing the buildings of the geographic area, wherein the thermal resistance value characterizes a rate of energy transfer by each of the buildings due to conductance and the thermal capacity value characterizes an amount of energy used to change an indoor temperature of each of the buildings per unit change in temperature; and
modeling HVAC operation for a particular building of the geographic area using a thermal resistance-capacity model and the thermal resistance value and the thermal capacity value for the buildings of the geographic area.

18. The non-transitory computer storage medium of claim 17, wherein determining the thermal resistance value and the thermal capacity value comprises:
initializing an estimated thermal resistance value and an estimated thermal capacity value;
determining modeling values for: indoor set-point temperatures including a high temperature and a low temperature, peak power HVAC operation, and minimum HVAC cycle time;
determining a predicted value of HVAC energy consumption using the estimated thermal resistance value, the estimated thermal capacity value, the modeling values, the outdoor temperature data, and the thermal resistance-capacity model;
determining a modeling error for the predicted value of HVAC energy consumption using the disaggregated HVAC load data; and
repeatedly adjusting the estimated thermal resistance value and estimated thermal capacity value, updating the predicted value of HVAC energy consumption, and updating the modeling error until the estimated thermal resistance value and estimated thermal capacity value minimizes the modeling error.

19. The non-transitory computer storage medium of claim 17, wherein modeling HVAC operation comprises determining an HVAC on/off state time series using indoor set-point temperatures including a high temperature and a low temperature.

20. The non-transitory computer storage medium of claim 19, wherein modeling HVAC operation comprises determining an HVAC energy consumption time series using the HVAC on/off state time series and a peak power HVAC operation value.
